(19) United States
(12) Patent Application Publication
(10) Pub. No.: US 2009/0262471 A1
(43) Pub. Date: Oct. 22, 2009

(54) Arc Fault Circuit Interrupter (AFCI) Support

(75) Inventors: Bill Nicolay, Loveland, CO (US); Robert A. Pries, Broomfield, CO (US)

Correspondence Address: Berenbaum Weinshienk PC, 370 17th Street, Republic Plaza, Suite 4800, Denver, CO, 80202, US

(73) Assignee: COLORADO VNET LLC, Loveland, CO (US)

(21) Appl. No.: 12/426,049

(22) Filed: Apr. 17, 2009

Related U.S. Application Data
(60) Provisional application No. 61/046,321, filed on Apr. 18, 2008.
(60) Provisional application No. 61/046,381, filed on Apr. 18, 2008.
(60) Provisional application No. 61/046,435, filed on Apr. 20, 2008.

(51) Int. Cl. H02H 9/08

(52) U.S. Cl. 361/42

(57) ABSTRACT

An Arc Fault Circuit Interrupter support system and program, having a plurality of sequenced individual loads arranged in scenes or groups, which sequenced individual loads when activated together form a cumulative total of 800 watts or more; and one or both of a delay between each sequenced individual load to prevent the cumulative wattage from creating a nuisance Arc Fault Circuit Interrupter breaker trip, and a plurality of pre-heat pulses provided to individual loads with individual wattages of 800 watts or more prior to applying a full current to the individual load.

### CROSS REFERENCE TO RELATED APPLICATIONS

This application claims the benefit of priority under 35 U.S.C. § 119(e) from U.S. Provisional Patent Application No. 61/046,321, entitled “Arc Fault Circuit Interrupter (AFCI) Support”, filed Apr. 18, 2008; U.S. Provisional Patent Application No. 61/046,381, entitled “Arc Fault Circuit Interrupter (AFCI) Support”, filed Apr. 18, 2008; and U.S. Provisional Patent Application No. 61/046,435, entitled “Arc Fault Circuit Interrupter (AFCI) Support”, filed Apr. 20, 2008, all of which are incorporated herein in their entirety by this reference.

### BACKGROUND

According to the National Fire Protection Association and the National Fire Incident Reporting System data, during the five-year period from 1994 to 1998, there were an average of 73,500 annual electrical fires that were responsible for 591 deaths, 2,247 injuries, and property damage totaling $1,047,900,000. A report by the National Association of State Fire Marshals states that of these 73,500 electrical fires, 60,900 or 82% were caused by arcing, not overloads or short circuits. Arcing is the phenomenon that occurs when the electrons of an electric current, often strong, brief, and luminous, jump across a gap. Unwanted arcs in electrical circuits can cause fires.

Starting in 2002, the National Electrical Code (NEC) requirements in article 210.12 state, “All branch circuits that supply 125-volt, single-phase, 15- and 20-ampere outlets installed in dwelling unit bedrooms shall be protected by an AFCI listed device to provide protection of the entire branch circuit.” This includes outlets for receptacles, lights, fans, and smoke detectors in circuits that supply bedrooms.

Indeed, although the 2002 NEC code required AFCI protection only in bedrooms, many state and local “authorities having jurisdiction” (AHJs) adopted more restrictive policies, requiring AFCIs in all living spaces of a home. Beginning January 2008, only “combination type” AFCIs will meet the NEC requirement. The 2008 NEC code requires installation of combination-type AFCIs in all 15- and 20-amp residential circuits with the exception of laundries, kitchens, bathrooms, and garage, and unfinished basements. The insurance industry was involved in this direction as one of the main preventative actions to reduce electrical fires. This will likely increase implementation of AFCI support to reduce nuisance tripping.

“Nuisance tripping” takes place when an AFCI generates a trip signal with no actual arcing taking place. Current dimming module behavior does not support AFCI breakers which can cause them to trip indefinitely. This may be due to several possibilities, one of which is that with no stipulation prohibiting the separation of lighting and general-use outlets with regard to the branch circuits that feed them, it is common practice to combine these loads within rooms. It is then possible and probable that a single load or group of loads exceeding 800 watts can be simultaneously activated from a control station, thus creating a nuisance trip of the corresponding AFCI breaker.

To the AFCI breaker, cold filaments in incandescent lamps appear as having a much lower resistance until they warm up and reach the designed higher resistance value. For example, this initial resistance may be about 1/10 of its ultimate designated higher resistance value. Standard light switches do not have this effect on an AFCI breaker due to the inherent contact bounce that occurs when a light switch is turned on. This contact bounce allows the filaments to be “pre-heated” if even for a millisecond, before presenting the full load to the breaker. Solid state dimmers, however, do not have the contact bounce, but rather present the entire cold filament load to the breaker, from zero to full-load-amps in less than two half cycles. Solid state dimmers routinely contribute to nuisance tripping when supplied by an AFCI, combined with the control of loads greater than 800 watts or more.

An AFCI opens the circuit for low-level line-to-neutral faults when three to eight half-cycles exceed 50 A peak (within 0.5 second), whereas a standard circuit breaker might not open for many hundreds of half-cycles. The arc fault detection circuit includes a controller which produces a trip signal in response to a determination that an arcing fault is present in the electrical circuit, and an inhibit/blocking function for preventing the production of the trip signal under one or more predetermined conditions.

### SUMMARY

The following implementations and aspects thereof are described and illustrated in conjunction with systems, which are meant to be exemplary and illustrative, not limiting in scope. In various implementations, one or more of the above-described issues have been reduced or eliminated, while other implementations are directed to other improvements.

In view of the foregoing it is a general aspect of the presently described developments to provide for a support system for an Arc Fault Circuit Interrupter; by including functionalities and/or devices for providing for a delay between each load to prevent the cumulative wattage from creating a nuisance AFCI breaker trip, or by providing a number of pre-heat pulses prior to applying the full current to the load.

The foregoing specific aspects and advantages of the present developments are illustrative of those which can be achieved by these developments and are not intended to be exhaustive or limiting of the possible advantages which can be realized. Thus, those and other aspects and advantages of these developments will be apparent from the description herein or can be learned from practicing the disclosure hereof, both as embodied herein or as modified in view of any variations which may be apparent to those skilled in the art. Thus, in addition to the exemplary aspects and embodiments described above, further aspects and embodiments will become apparent by reference to and by study of the following descriptions.

### BRIEF DESCRIPTION OF THE DRAWINGS

In the drawings:

FIG. 1 is a screen shot of a window within the user interface.

FIG. 1 (a) is an additional screen shot of a window within the user interface, which displays the pull-down menu for selecting the breaker size and Arc Fault.

FIG. 2 shows a message generated to the user regarding the wattage selected.

FIG. 2 (a) shows an additional message generated to the user regarding the wattage selected.

FIG. 3 is another screen shot of a window within the user interface.

FIG. 4 is a flow chart of a methodology hereof.

### DESCRIPTION

Described here is an Arc Fault Circuit Interrupter (AFCI) Support to eliminate nuisance tripping caused by solid state dimmers. Through unique firmware and software enhancements, here referred to as “AFCI Support,” reliable control can be had of incandescent lighting loads greater than 800 watts with little or no nuisance tripping of AFCI breakers that supply them, by using two different methods hereinafter referred to as Level One Support and Level Two Support.

In Level One Support, individual loads, arranged in scenes or groups, which when activated together, form an accumulated total of 800 watts or more, can hereby be “sequenced” with a delay, e.g., a 1 millisecond delay, between each load to prevent the cumulative wattage from creating a nuisance AFCI breaker trip.

In Level Two Support, loads with individual wattages of 800 watts or more can be provided with a number, e.g., two, “pre-heat” pulses prior to applying the full current to the load. If there is more than one load of 800 watts or more being activated, each load may receive a pulse, as well as being sequenced with a delay (e.g., the millisecond delay of Level One Support) between each individual load.

Moreover, an alternative may be to let in some high level current (or high RMS value, i.e. the effective value of a varying current) for a short period, e.g., a short number of seconds. Such high level current might be more or less than that needed for regular operation. Another alternative may be to provide something less than full power initially to moderate the value, and/or may be to step up the power over time, and/or to step up the value of two or more different “pre-heat” pulses. For example, perhaps a quarter power pulse or step followed by a half power step or pulse, and/or in some cases one or the other or both of the previous followed by a three-quarters power step or pulse. These are exemplar values only, other greater or lesser values may be uses at any of these points.

Still furthermore, an application hereof may be described in the following manner. The length or level of a particular one or more pulses, whether referred to as “pre-heat” pulses or otherwise, e.g., rather as delays; may be tuned to or for the particular load. For example, some possible alternative lighting “loads” may include halogen, quartz, incandescent or fluorescent, inter alia. Each of these may, however, present a different in-rush current need relative to the AFCI. For example it has been found that a tuned cycle for a pulse hereunder for a halogen light load may be about half that used for a quartz light load; thus, if as it has been found, a halogen light load may use a 1.5 cycle pulse, a quartz light load might use a 3 cycle pulse according hereto. Other numbers or cycles may be used depending upon the load.

However, the present development may take these different references and “program” or provide for them to be programmed according to end-user desire. For example, an end-user can use a system hereof (hardware, firmware or software, or any combination thereof) to “program” for the particular “load” to be used. Indeed, the system may only require input of the particular minimum information of, for example, whether an AFCI is being used, and then what type of light “load” is being used, whether halogen, quartz, incandescent or fluorescent, inter alia. Then, the system may provide for the pre-selected pulse for that load. A system hereof could thus be used with one or a plurality of zones, each zone potentially having different types of “loads”; and the system providing the appropriate pulse length or level (one quarter, one half, or three quarters or some other percentage of total).

An exemplar implementation will now be set forth.

### EXAMPLES

The example given herein uses a dimming module. Dimming module firmware can be modified according hereto to understand a new arc fault flag that in this example can have one of 3 possible states to determine the turn on behavior.

The first state, State 1, may be a default state. State 1 involves no new behavior, but rather may turn on lights using current dimming behavior. State 2, also known as arc fault level 1, may involve some millisecond between turning on each dimmer leg. No pulsing is necessarily required during this State 2. State 3, also known as arc fault level 2, may involve some millisecond delay between turning on each dimmer leg. All legs may be pulsed twice to warm up the load.

Dimming module setup may include the following steps. The user may be prompted to specify one of the following, for example: a 15 amp breaker, a 20 amp breaker, a 15 amp arc fault breaker or a 20 amp arc fault breaker.

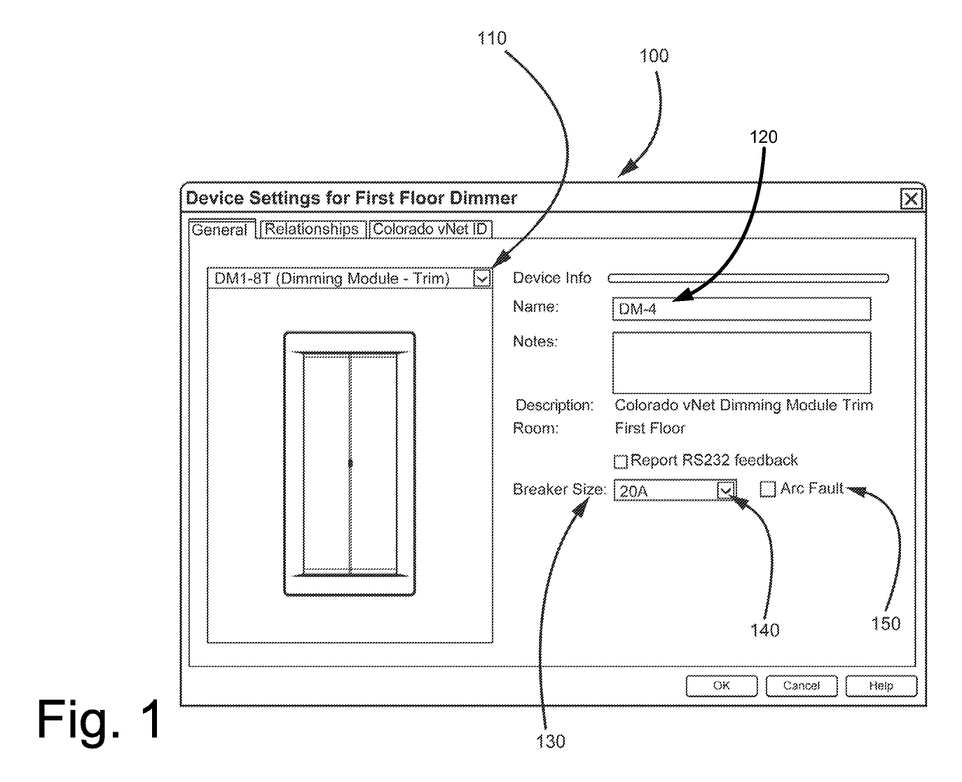

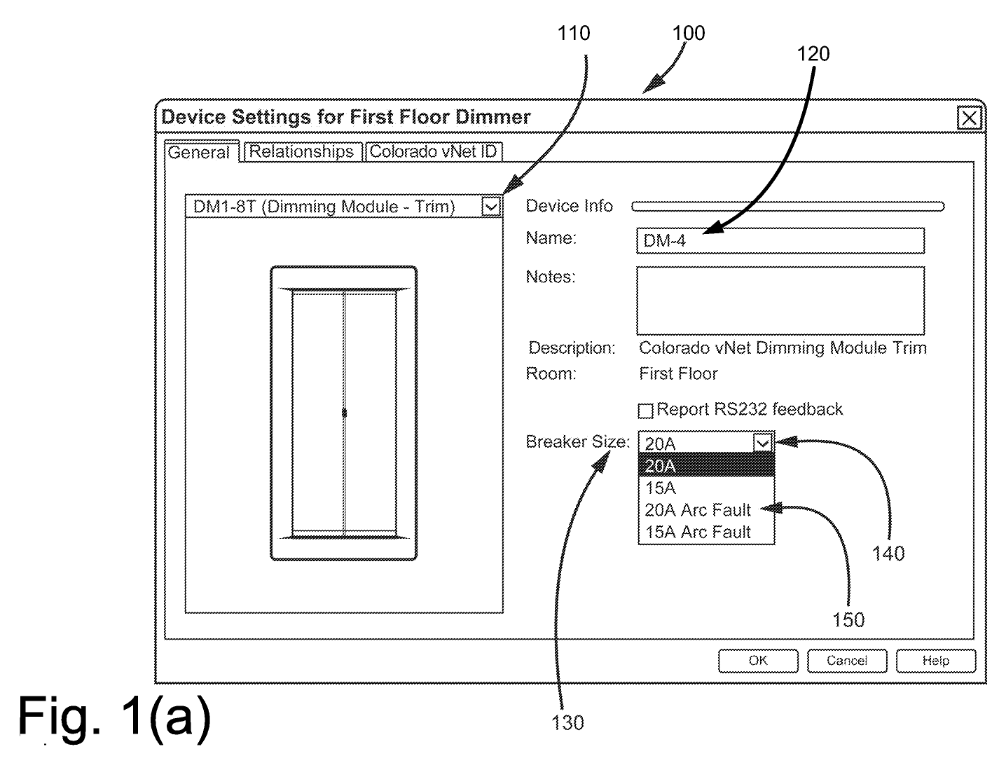

A dimming module may be entered into a floor plan by drag and drop in programming the floor plan. As illustrated in FIG. 1 and FIG. 1 (a), when a dimming module is entered into a floor plan, the user may set the amperage. The user may also check or otherwise select the Arc Fault feature.

In FIG. 1, a screen shot 100 of the user interface illustrates the user options with respect to the dimming module 110. The name 120 of the particular device is DM-4. The breaker size 130 of the particular device is 20 A (non arc-fault); however, the breaker size may be modified by the user selecting a different amperage from the pull-down menu 140. The Arc Fault feature box 150 is unchecked in FIG. 1, however, it may be checked by the user to change the status of the device. Alternatively, in FIG. 1 (a), the user may control the Arc Fault 150(a) while selecting a different amperage from the pull-down menu 140(a).

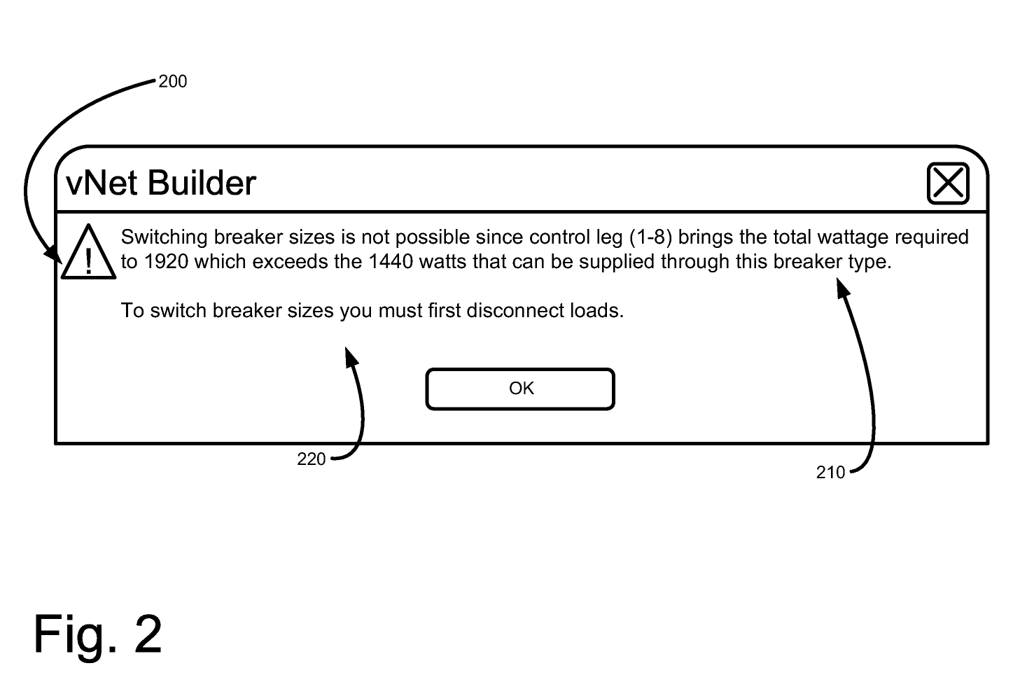

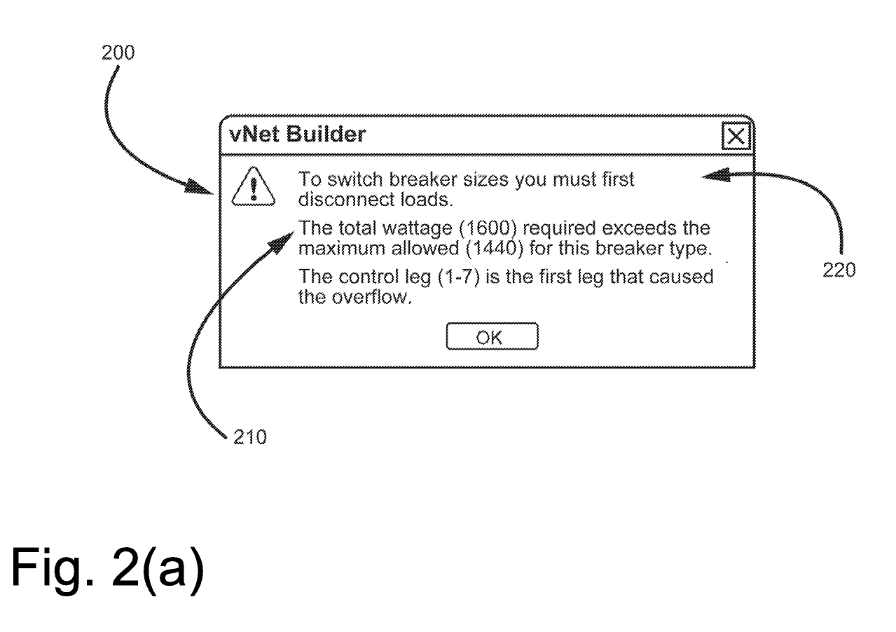

As illustrated in FIG. 2, builder programming support may generate messages to the user regarding the total wattage selected. This programming support may give helpful user feedback pertaining to total wattage allowed. This message 200 in FIG. 2 may be generated to prevent overload of the system and guide the user through and to an allowed configuration. The message 210 provides the user with information such as a description of the wattage required by the action and the total amount of wattage that can be supplied by the breaker. The message 220 may instruct the user as to how to proceed to resolve the problem at hand. Alternatively, in FIG. 2(a), the message 200 appears wherein the message 220 appears first, which instructs the user as to how to proceed to resolve the problem at hand. Message 210 provides the user with information such as the description of the wattage required by the action and the total amount of wattage that can be supplied by the breaker.

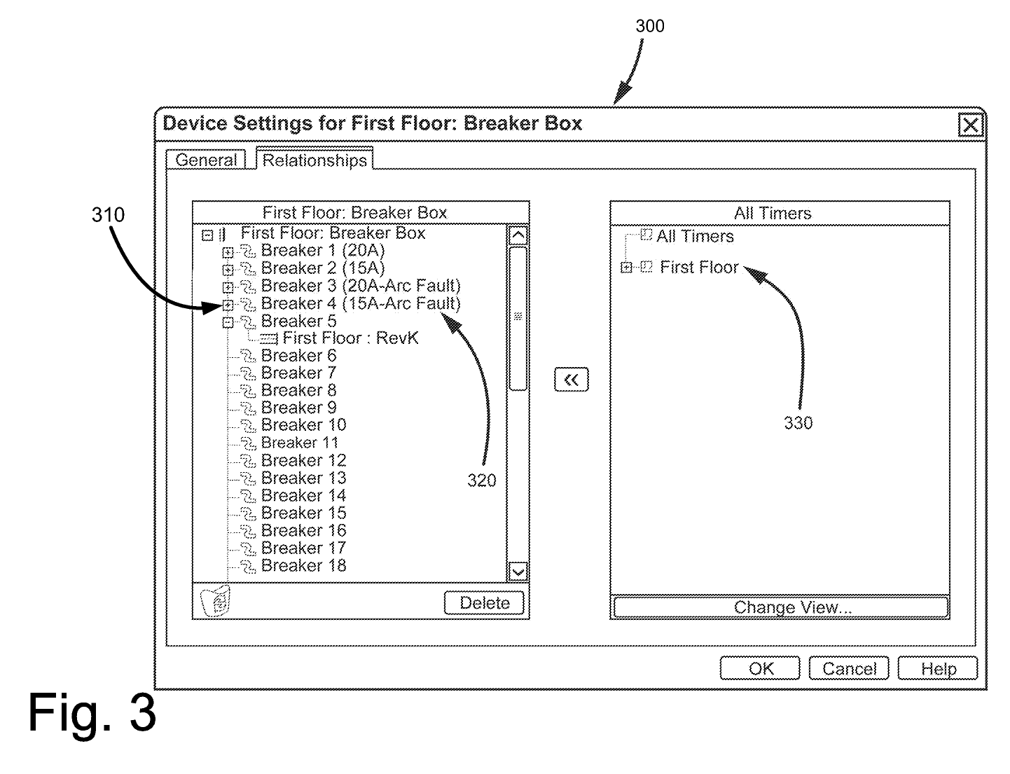

When a dimming module is wired to a breaker box, the breaker box may be set to inherit the amp and arc fault properties. As shown in FIG. 3, the screen shot 300 illustrates that Breaker 4, shown as 310, inherits the amp and arc fault properties of the dimming module 320 on the First Floor 330 to which it is wired. Note, only properties from dimming modules are displayed in FIG. 3; breaker wire to other device types, such as, for example, fluorescent ballasts, is not.

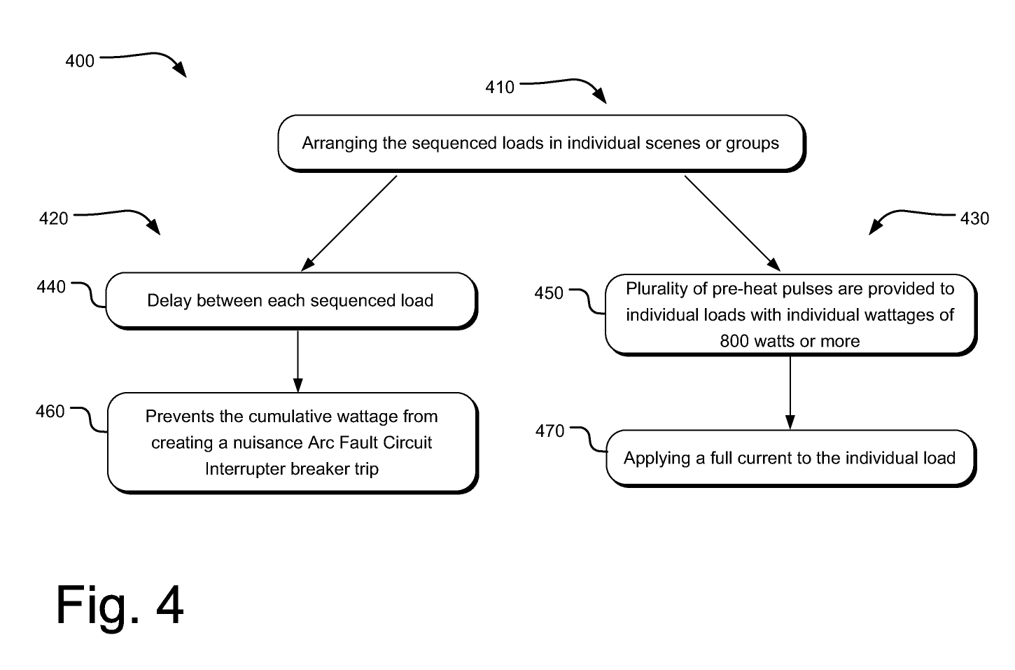

FIG. 4 is a flow chart 400 illustrating the methodology of the present system and process. Step 410 constitutes arranging the sequenced individual loads in scenes or groups. When activated together to form a cumulative total of 800 watts or more, the methodology follows either Level One Support (leg 420) or Level Two Support (leg 430). In Level One Support 420, a delay between each sequenced individual load 440 prevents the cumulative wattage from creating a nuisance Arc Fault Circuit Interrupter breaker trip 460. In Level Two Support 430, a plurality of pre-heat pulses are provided to individual loads with individual wattages of 800 watts or more 450 prior to applying a full current to the individual load 470.

The builder programming support may determine the appropriate state for each dimming module script based on the breaker and load wattages. Table 1 provides examples of the scripts to be run in particular amp and total wattage situations.

TABLE 1

| | Total Wattage | Total Wattage over | Total Wattage over |
|---|---|---|---|
| | less than | 800 Watts, but NO leg | 800 Watts and leg is |
| | 800 Watts | is over 800 Watts | over 800 Watts |
| 20 Amp | Default | Default | Default |
| 15 Amp | Default | Default | Default |
| | Total Wattage | Total Wattage can not | Total Wattage can not |
| | can not | exceed 1440 | exceed 1440 |
| | exceed 1440 | | |
| 20 Amp | Default | Level 1 Arc Fault - | Level 2 Arc Fault - |
| Arc | Total Wattage | millisecond delay | millisecond delay |
| Fault | can not | between each dimmer | between legs AND |
| | exceed 1500 | leg | each load pulses twice |
| | | Total Wattage can not | before turning on. |
| | | exceed 1500 | Total Wattage can not |
| | | | exceed 1500 |
| 15 Amp | Default | Level 1 Arc Fault - | Level 2 Arc Fault - |
| Arc | Total Wattage | millisecond delay | millisecond delay |
| Fault | can not | between each dimmer | between legs AND |
| | exceed 1440 | leg | each load pulses twice |
| | | Total Wattage can not | before turning on. |
| | | exceed 1500 | Total Wattage can not |
| | | Total Wattage can not | exceed 1440 |
| | | exceed 1440 | |

What is claimed is:

1. An Arc Fault Circuit Interrupter support system comprising:
a plurality of sequenced individual loads arranged in scenes or groups, which sequenced individual loads when activated together form a cumulative total of 800 watts or more; and
a delay between each sequenced individual load to prevent the cumulative wattage from creating a nuisance Arc Fault Circuit Interrupter breaker trip.

2. An Arc Fault Circuit Interrupter support system according to claim 1, wherein the delay is a 1 millisecond delay.

3. An Arc Fault Circuit Interrupter support system comprising:
a plurality of sequenced individual loads arranged in scenes or groups, which sequenced individual loads when activated together form a cumulative total of 800 watts or more; and
a plurality of pre-heat pulses provided to individual loads with individual wattages of 800 watts or more prior to applying a full current to the individual load.

4. An Arc Fault Circuit Interrupter support system according to claim 3, wherein the number of pre-heat pulses is two.

5. An Arc Fault Circuit Interrupter support system according to claim 3, further comprising a pulse for each load and a delay between each sequenced individual load to prevent the cumulative wattage from creating a nuisance AFCI breaker trip when there is more than one load of 800 watts or more being activated.

6. An Arc Fault Circuit Interrupter support system according to claim 3, wherein the delay is a 1 millisecond delay.

7. (canceled)

8. An Arc Fault Circuit Interrupter support system comprising:
a plurality of sequenced individual loads arranged in scenes or groups, which sequenced individual loads when activated together form a cumulative total of 800 watts or more; and one or both of:
a delay between each sequenced individual load to prevent the cumulative wattage from creating a nuisance Arc Fault Circuit Interrupter breaker trip;
a plurality of pre-heat pulses provided to individual loads with individual wattages of 800 watts or more prior to applying a full current to the individual load.

9. An Arc Fault Circuit Interrupter support system according to claim 8, further comprising high level current or high RMS value current let into the system.

10. An Arc Fault Circuit Interrupter support system according to claim 8, wherein the high level current or high RMS value current let into the system for a short number of seconds.

11. An Arc Fault Circuit Interrupter support system according to claim 8, further comprising high level current or high RMS value current let into the system.

12. An Arc Fault Circuit Interrupter support system according to claim 8, further comprising less than full power given to the system initially to moderate the value.

13. An Arc Fault Circuit Interrupter support system according to claim 8, further comprising power to the system provided in a stepwise manner.

14. An Arc Fault Circuit Interrupter support system according to claim 8, further comprising power to the system provided in a stepwise manner via two or more different pre-heat pulses.

15. An Arc Fault Circuit Interrupter support system according to claim 8, wherein the “pre-heat” pulses comprise a quarter power pulse followed by a half power pulse.

16. An Arc Fault Circuit Interrupter support system according to claim 15, further comprising a three-quarter power pulse following the quarter power pulse and half power pulse.

17. An Arc Fault Circuit Interrupter support system according to claim 8, further comprising pulses tuned to or for a particular load.

18. An Arc Fault Circuit Interrupter support system according to claim 17, wherein the particular load is one or more of halogen, quartz, incandescent, or fluorescent.

19. (canceled)

20. (canceled)

21. (canceled)

22. (canceled)
